(19) United States
(12) Patent Application Publication
(10) Pub. No.: US 2014/0379199 A1
(43) Pub. Date: Dec. 25, 2014

(54) METHOD FOR AGING-EFFICIENT AND ENERGY-EFFICIENT OPERATION IN PARTICULAR OF A MOTOR VEHICLE

(71) Applicants: Udo SCHULZ, Vaihingen/Enz (DE); Christian STAENGLE, Bamberg (DE); Bastian BISCHOFF, Esslingen (DE); Jochen PFLUEGER, Simmozheim (DE); Oliver Dieter KOLLER, Weinstadt (DE)

(72) Inventors: Udo SCHULZ, Vaihingen/Enz (DE); Christian STAENGLE, Bamberg (DE); Bastian BISCHOFF, Esslingen (DE); Jochen PFLUEGER, Simmozheim (DE); Oliver Dieter KOLLER, Weinstadt (DE)

(73) Assignee: ROBERT BOSCH GMBH, Stuttgart (DE)

(21) Appl. No.: 14/303,170

(22) Filed: Jun. 12, 2014

(30) Foreign Application Priority Data
Jun. 19, 2013 (DE) 10 2013 211 543.1

(51) Int. Cl. B60W 40/12

(52) U.S. Cl. CPC B60W 40/12
USPC 701/29.2

(57) ABSTRACT

A method for operating a motor vehicle having at least one component which is subject to an operation-dependent aging process, in which the connection between a load profile of the at least one component and a damage resulting therefrom is determined, and the damage of the at least one component is estimated from the determined connection, and in which an operating strategy for operating the motor vehicle is set on the basis of the estimated damage of the at least one component.

### CROSS REFERENCE

The present application claims the benefit under 35 U.S.C. §119 of German Patent Application No. DE 10 2013 211 543.1 filed on Jun. 19, 2013, which is expressly incorporated herein by reference in its entirety.

### FIELD

The present invention relates to a method for operating a motor vehicle, a computer program which executes the steps of the method, when it is run on a computer or a control unit, as well as a computer program product having program code which is stored on a machine-readable medium, for carrying out the method when the program is executed on a computer or a control unit.

### BACKGROUND INFORMATION

In the field of automotive technology, parts or components, for example, a high-voltage drive battery (“traction battery”) of an electric or hybrid vehicle or a throttle valve situated in the intake system of a gasoline engine and provided for controlling the volume of air in an intake manifold, are subject to an aging process which is a function of the operating mode of the motor vehicle and therefore also the resultant service life of the respective component. Other components also subject to such an aging process are wear parts such as, for example, tires, brake pads or the clutch plate of a transmission clutch.

German Patent Application No. DE 10 2009 024 422 A1 describes a method for estimating the service life of an aforementioned battery of a hybrid vehicle in which the aging and thus the expected service life of the battery is ascertained on the basis of a frequency distribution of the values of at least one operating parameter. In particular, a prognosis is made about the expected service life by applying a so-called “Miner rule,” the aging being determined as a result of linear damage accumulation.

German Patent Application No. DE 10 2010 051 016 A1 describes a method for cost- and aging-optimized charging of a traction battery in which a state of charge is generated via the initiating charge of the battery, which is optimal with respect to predefined characteristic values, for example, the aging of the battery.

Furthermore, German Patent Application No. DE 10 2007 020 935 A1 describes a method for drive control of hybrid vehicles with the traction battery under high load, in which the performance of the electric drive or the electric engine may be limited as the case may be depending on the battery temperature and the degree of aging of the battery.

### SUMMARY

The present invention relates to a method for the creation of a strategy for operating a motor vehicle based on a damage prognosis, which is preferably optimal with regard to the aging of at least one component of the motor vehicle and to the operating efficiency of the motor vehicle, for example, with regard to energy or fuel consumption. In this way the target service life of the component may be preferably achieved and at the same time the component or the motor vehicle may be operated with favorable or optimum performance.

The aforementioned components preferably involve traction batteries or power semiconductors used in electric or hybrid vehicles. However, the present invention may also be used with the advantages described herein in conjunction with other components of a motor vehicle, for example, components of the intake system of an internal combustion engine, for example, a throttle valve, or in conjunction with wear parts such as, for example, tires, brake pads or a transmission clutch.

An aforementioned damage of the at least one component is ascertained according to the present invention by determining the connection between a load profile and the damage resulting therefrom. Damage to the at least one component is preferably estimated based on parameters at the motor vehicle level or the motor vehicle systems level. Such an estimation is managed with no additional and generally costly sensors, whereby the operating strategy may, in addition, be set with as few system interventions as possible.

Alternatively, the connection between damage and load profile may also be based on stress parameters. Such stress parameters may be model-based or may be determined with the aid of additional sensors.

The example method according to the present invention therefore allows an adaptation of the operating strategy during operation of the vehicle, an optimization of performance, in particular, (for example, drive performance or CO₂ reduction) being possible while maintaining a target service life for each component. The early detection of overloads of the component may minimize required interventions into the system.

For each operating strategy the expected service life of the component is predicted in conjunction with a given load profile. A preferably global load profile, i.e., valid for multiple components, may be formed individually or in combinations thereof as a result of various environmental conditions. In a motor vehicle, such environmental conditions are, for example, speed-time curves or slope-time curves, or the outside temperature or air moisture which occur during driving operation.

The aforementioned connection is preferably determined with the aid of an approximation method or regression method, the damage being determined for several load profiles with the aid of sensors situated in the motor vehicle and, using the regression method, a generalization of the present specific case being applied to a larger range of load profiles.

Preferably, the regression method is used in advance, for example, at a test stand or during manufacture of the respective component, sensors being employed to determine the damage. In the subsequent standard product these additional sensors for measuring the aforementioned load parameters may be advantageously eliminated, the previous damage of the component being estimated without the aforementioned sensors based on the past load profile alone and the operating strategy used.

Alternatively or in addition, the expected service life of the component may be estimated for various operating strategies, assuming an unchanging load profile. During operation the respective operating strategy may then be selected in such a way that a desired service life is achieved under optimal performance. No further adjustments are necessary in this case, due to the unchanging load profile.

The damage to the component may be determined based on a damage parameter D, which represents a function increasing monotonously over time. The function may be a linear function or a chronological sequence of local linear partial functions. Such a damage parameter allows for a technically simple and therefore cost-efficient implementation of the method provided.

The values of damage parameter D may also be ascertained through a learning process, whereby a linear damage accumulation of partial damages may be provided. The accuracy of the damage prognosis may be improved as a result of the learning process.

In the example method, the operating strategy is set or regulated depending upon the actual damage and the target damage, the switch being made to a less protective or non-protective operating strategy in the event of non-critical actual damage, in contrast to the related art. This approach makes it possible, in contrast to the related art, to use an operating strategy which both increases performance or fuel savings (by increasing the electrical operating parts) of the motor vehicle or the electric drive, as well as reduces, and thereby accelerates or slows the aging process and damage to the respective component. In the process the behavior of the vehicle, as a result of the respective operating strategy, is adapted to the individual damage behavior of the vehicle driver, or a different vehicle behavior results from a different previous history of the vehicle operation.

Further advantages and embodiments of the present invention result from the description below and the figures.

It is understood that the above-cited features and features explained below may be used not only in each of the specified combinations, but in other combinations as well or alone, without departing from the scope of the present invention.

### BRIEF DESCRIPTION OF THE DRAWINGS

FIG. 1 shows example method steps according to one first aspect of the present invention.

FIG. 2 shows example method steps according to one second aspect of the present invention.

FIG. 3A shows an illustration of the statistical influence of the driving mode of a motor vehicle on its acceleration behavior.

FIG. 3B shows an illustration of further statistical influence similar to FIG. 3A.

FIG. 3C shows an illustration of further statistical influence similar to FIGS. 3A and 3B.

FIG. 4 shows a training of a regression curve in accordance with the present invention.

FIG. 5 shows a test in accordance with the present invention of a trained regression curve as in FIG. 4.

FIG. 6 shows a typical failure behavior of a component as a function of the operating strategy.

FIG. 7 shows one exemplary embodiment of the method according to the present invention for deriving a suitable operating strategy.

### DETAILED DESCRIPTION OF EXAMPLE EMBODIMENTS

The following description is based on a prognosis or estimation of the failure or service life of a component or part of a motor vehicle, a load profile for a given operating strategy being formed on a quantified damage of the component or part. It is understood that, for example, available sensor variables may be used for improving the prognosis quality.

An aforementioned operating strategy may be used at the vehicle level or the component level. At the vehicle level, a speed limitation or torque limitation may be carried out, for example, in order to influence the aging process of a component. At the component level, for example, in the case of a traction battery, it is possible alternatively or in addition to influence the discharge and/or charge process.

In the case of a vehicle, for example, a global load profile may be derived from the speed-time curve as well as the temperature curve of the component. Alternatively, the aforementioned time curves may be obtained by statistical methods, such as averaging the speed, the variance in speed, the frequency of acceleration classes or the like.

According to one preferred embodiment, the used service life of the component is described with a damage parameter D which represents a function increasing monotonously over time. At point in time t=O, D=0, i.e., the component is initially assumed as 100% intact. The point in time at which the value D=1 prevails is considered a potential instant of failure (i.e., the component is defective) with a given failure probability.

The values of D may be ascertained through a learning process, values of D being determined via a linear damage accumulation of partial damages. Since in this case affected components of the motor vehicle age similarly to a mechanical stress cycle or to a temperature cycle, the aforementioned partial damages may be determined based on a so-called “Wöhler curve” with a defined failure probability. “Wöhler curves” describe the connection between component load and component service life.

Here, there are two possible courses of action:
1. Measurement/simulation of the input parameters of a service life model during operation and a calculation of the change in D;
2. Estimation of the change in D through a learning process.

The Wöhler method is used in mechanical engineering to determine the fatigue strength of a part. So-called “Wöhler tests” are also carried out, for example, for temperature surges.

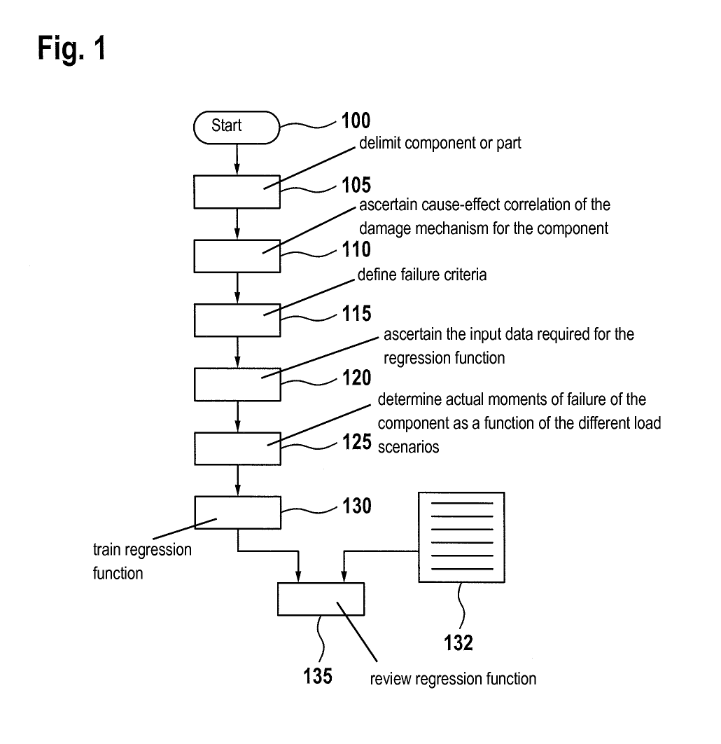

The connection between load profile and damage of a component may be ascertained analytically or based on data. In the exemplary embodiment of the example method according to the present invention shown in FIG. 1, using as an example an aforementioned traction battery of an electric vehicle, the damage or the aforementioned connection was ascertained using data-based regression, i.e., by ascertaining a suitable regression function for describing this connection. In this exemplary embodiment the damage for several load profiles is determined with the aid of additional sensors situated in the motor vehicle. With the aid of the regression method described in greater detail below, it is then possible from these examples to inter-/extrapolate, or generalize to, a larger range of load profiles.

In the aforementioned regression method, after start 100 of a routine shown in FIG. 1, the component or part of the motor vehicle is initially delimited 105 from the higher-level system in order to minimize or prevent interactions between the component and the system. In the following step 110 the cause-effect correlations of the damage mechanism are ascertained for the component, i.e., which processes at the system level bring about or stimulate the damage mechanism at the component level.

In step 115 the failure criteria for the component are defined, i.e., at what point the component should be considered to have failed. Thereafter, the input data required for the regression function are ascertained 120, i.e., based on the quantity of the aforementioned statistical moments and histogram data, parameters are defined which (given knowledge of the damage mechanism) influence the damage of the component.

On the basis of the ascertained input data, i.e., as a function of the different load scenarios, actual moments of failure of the component are determined in step 125. In the load scenarios, it is possible, particularly with respect to the training phase described below, to distinguish between training data and test data. In such a case, the moments may be estimated with the aid of modeling (simulative, for example) or also ascertained more precisely through real failures of the individual components during operation of a present vehicle. The available volume of data may also be increased by data networking of vehicles.

The aforementioned regression function is trained 130 using the aforementioned training data. In the process a connection is established between the aforementioned input data and the moments of failure. The assessment and selection of one individual regression function is accomplished in the present exemplary embodiment with the aid of known statistical methods, such as the least squares method, whereby parametric regression approaches, for example, Taylor polynomials, neural networks or support vector machines, as well as non-parametric regression approaches, for example, Gauβ processes, may be used. A typical result of a regression function trained in this way is shown in FIG. 4.

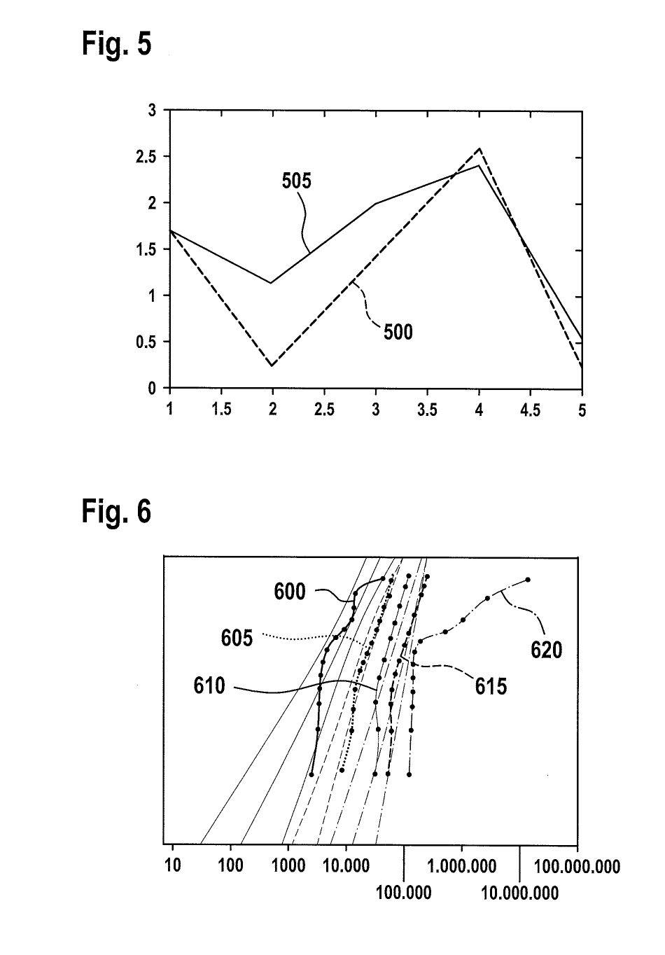

Based on the aforementioned test data 132, the respectively found or selected regression function is then reviewed in step 135, as illustrated in FIG. 5. To ensure the quality of the review, the value range of the input data for the test data must not deviate too much from the value range of the training data, since the extrapolation of the data otherwise required causes significant errors.

In FIGS. 4 and 5, values of damage parameter D are plotted over various actual and generic operating cycles. Here, curves 400, 500 represent moments of failure estimated with the aid of the regression function, and curves 405, 505 represent actually occurring moments of failure.

The routine shown in FIG. 1 is preferably carried out for each previously defined operating strategy. Alternatively, individual parameters of the operating strategies may serve as input parameters for the regression function, thereby making it possible to continuously adjust the operating strategy-parameters. The regression function is then a mapping of load profile and operating strategy-parameter onto damage parameter D. The exact selection of the operating strategy-parameter is a problem of optimization, the operating strategy-parameters being sought which are mapped by the regression function onto desired D.

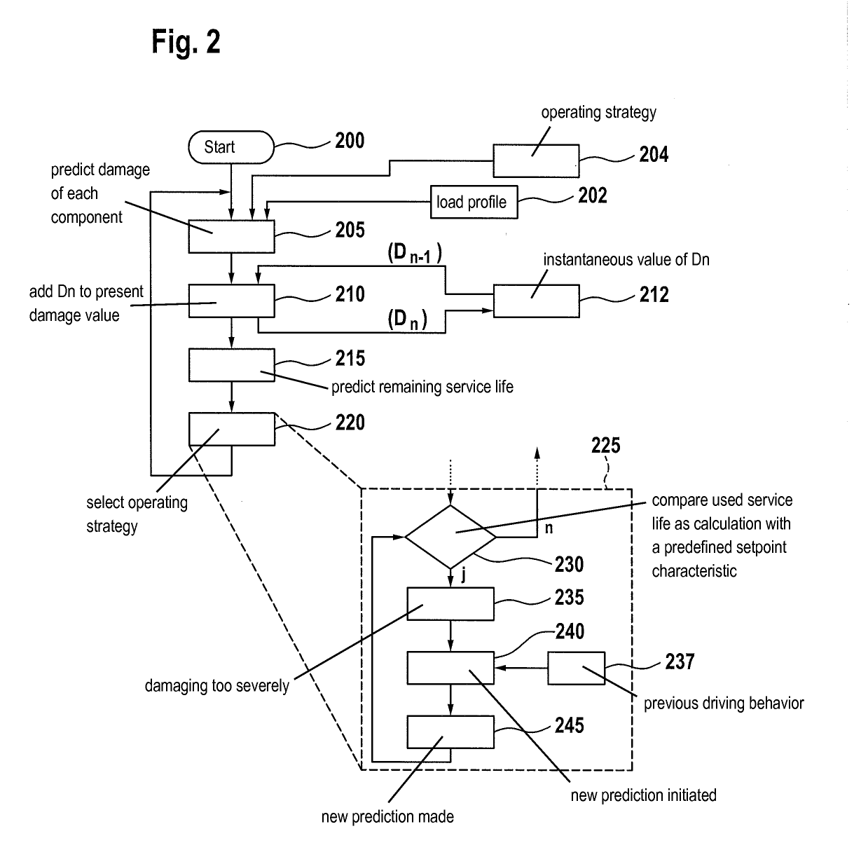

An ascertained regression function as described may be used according to the exemplary embodiment shown in FIG. 2. After start 200 of the routine shown in FIG. 2, a damage of each component in question is predicted 205, cyclically and in previously empirically ascertained time periods, on the basis of the load profile 202 used in the previous time period and of the present operating strategy 204 according to the above-mentioned method. Value Dₙ of the damage resulting in one cycle n is added 210 to an already present value Dₙ₋₁ of the damage. Thus, the already used service life of the component may be ascertained from the respective present value of D. The instantaneous value of Dₙ is stored in step 212.

The remaining service life of the component may be calculated from the thus ascertained value of the used service life. At this point, the remaining service life is now predicted 215 for various operating strategies on the basis of the load profile used in the previous time period or on the basis of several of the load profiles used in the previous time periods. Based on the results of this prediction, the operating strategy is selected or set 220 which results in a maximum performance, for example, maximum drive performance or maximum reduction in CO₂, but at the same time ensures the necessary reliability of the component or part in question. This setting of the operating strategy may be carried out at fixed intervals or when leaving an empirically predefined tolerance interval situated about a setpoint characteristic curve of damage D.

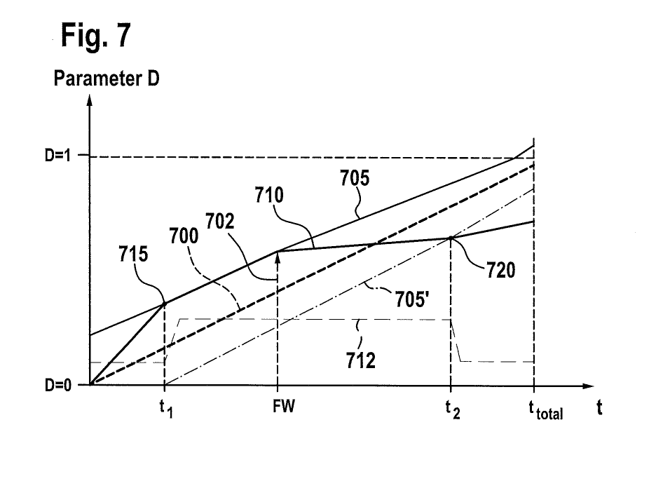

An exemplary embodiment of the aforementioned selection of an operating strategy is shown in FIGS. 6 and 7.

FIG. 6 shows so-called “Weibull failure rates” 600-620 for various previously defined operating strategies. A Weibull distribution is conventional for specifying, similarly to the aforementioned Wöhler curve, the probability of service lives of electronic components, materials, etc. For reasons of clarity, the failure rates 600-620 in the present case are sorted according to their relevance for the failure behavior of the component.

FIG. 7 shows an exemplary application of the example method according to the present invention in which the damage to the component of a vehicle is predicted in the case of a driver change. In the diagram shown, damage parameter D is plotted over a time t. Point in time t_total represents the target service life of the component. The point in time of the driver change (FW) is indicated by the perpendicular arrow 702. In the case of the driver change, it is assumed that the second driver driving after point in time FW drives the vehicle in a manner that is gentler on the component than the first driver driving prior to point in time FW.

FIG. 7 shows in particular a damage curve or curve of damage parameter D which represents damage curve 710 as well as an underlying operating strategy 712. The curve values of damage parameter (D) are formed in the exemplary embodiment by linear damage accumulation of partial damages of the component. In the present application scenario, a maximum strategy, i.e., an operating strategy for operating the motor vehicle with the highest possible damage rate for the component, is initially set. It should be emphasized that a lower value of the operating strategy in the diagram shown corresponds to a higher damage rate and, conversely, a higher value of the operating strategy corresponds to a lower damage rate.

The dashed lines 705, 705′ represent a tolerance range delimiting a setpoint characteristic curve 700 of damage parameter D upward and downward, whereby operating strategy 712 is changed if damage curve 710 exceeds or falls below the tolerance range. At point in time t1 (i.e., in point 715) the instantaneous damage value of damage curve 710 exceeds upper tolerance threshold 705. Hence, operating strategy 712 is changed in such a way that an operation of the motor vehicle which is gentler on the component is enabled. As a consequence of the gentler operating mode and in particular due to driver change 702 at point in time FW, the damage value falls below the lower tolerance threshold at point in time t2 (i.e., in point 720). Hence, operating strategy 712 is again changed in such a way that an operating mode or driving mode of the motor vehicle which is more damaging to the component is enabled.

The selection or setting of operating strategy 712 in step 220 is illustrated based on an application scenario described below taking place during operation of the motor vehicle, which is delineated in FIG. 2 by dashed line 225 with respect to the described routine. In step 230 of the scenario, a comparison of the used service life of the component as calculated above with a predefined setpoint characteristic curve reveals that the instantaneous value of the used service life is considerably removed from the setpoint characteristic curve. From this it is concluded 235 that the driver of the vehicle, by his/her mode of driving, is damaging the component too severely, in the present case a previously mentioned throttle valve. The comparison with the setpoint characteristic curve is made preferably based on a predefined tolerance range. If the tolerance range is exceeded or is fallen short of, a new prediction 240 is initiated based on the previous driving behavior 237 reproduced via the aforementioned statistical parameters. The new prediction is made on the basis of a selected 245, less damaging operating strategy. If the tolerance range is not exceeded or fallen short of, a return to start 205 of the routine is made, as is indicated by the dashed arrow on the right.

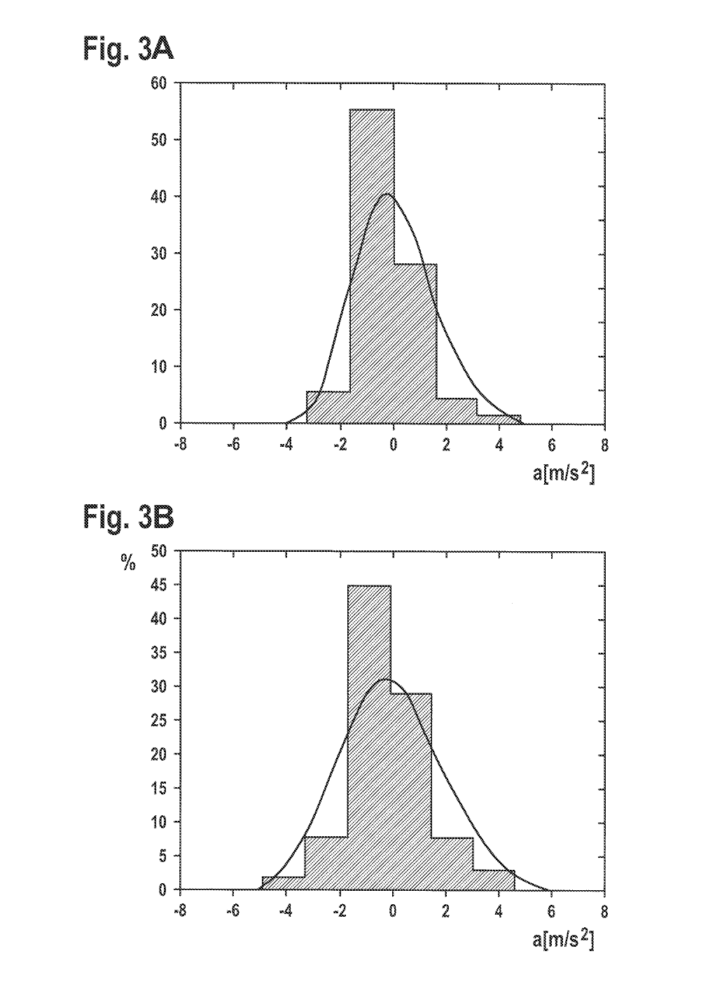

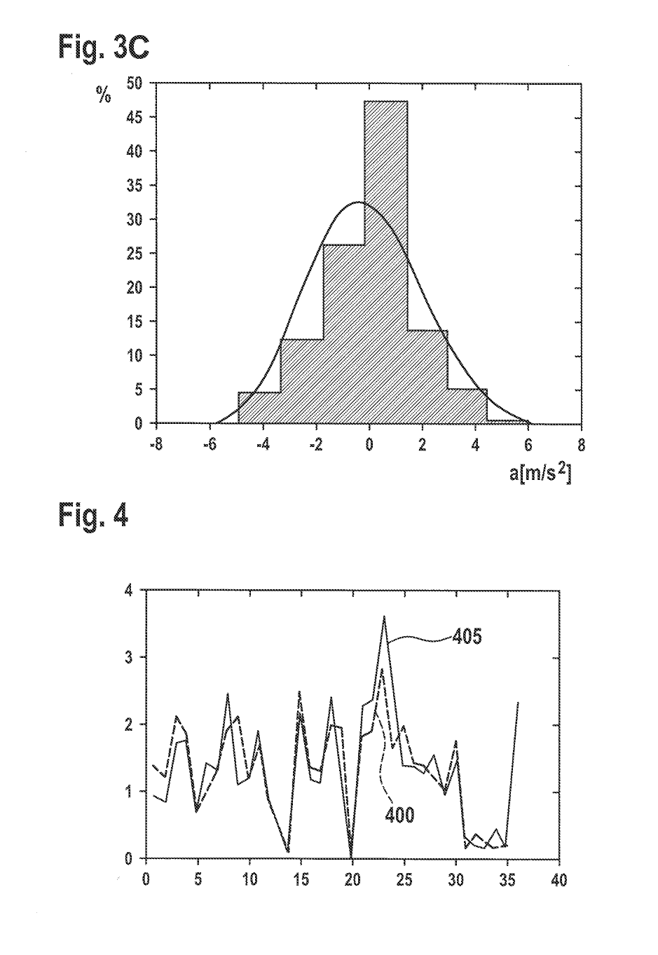

The influence of the driving mode is illustrated in FIGS. 3a through 3c, in which statistical findings of measured accelerations in conjunction with three different drivers are displayed. In FIG. 3a the driver was encouraged to drive a test track as relaxed as possible. In FIG. 3b the driver was to drive as normally as possible and in FIG. 3c was to drive in a sporty manner. As is apparent, the distribution of recorded acceleration values becomes flatter the sportier the driving style, and the kurtosis (peakedness of the curve) decreases. A broader distribution according to FIG. 3c also includes a number of relatively high acceleration values which reduces the service life of certain components or the like of the motor vehicle.

In the present scenario (see FIG. 7) it is assumed that after expiration of half the target service life of the component, a driver change takes place, the damage gradient dropping as a result of the driving behavior of the new driver. Thus, a renewed comparison 230 of the used service life of the component with the tolerance range of the setpoint characteristic curve reveals that the lower tolerance limit is fallen short of. From this it is concluded 235 that the present operating strategy, in combination with the driver influence, is less damaging to the component than would be permissible, yet at the same time does not utilize the maximum possible performance (i.e., the present service life would be longer than normally required). Hence, a new prediction is carried out 240, the previous driver behavior 237 again being taken into consideration. Since the present driving mode is less damaging to the component, the operating strategy is again switched back 245 to the previous maximum strategy.

It should be noted that the aforementioned tolerance limits are only preferred and the aforementioned comparison with the setpoint characteristic curve may, depending on the desired dynamic of the system, also be made without tolerance limits.

The method described may be implemented either in the form of a control program in an existing control unit for controlling an internal combustion engine or in the form of a corresponding control unit.

What is claimed is:

1. A method for operating a motor vehicle having at least one component which is subject to an operation-dependent aging process, the method comprising:
determining a connection between a load profile of the at least one component and a damage resulting therefrom;
estimating damage of the at least one component from the determined connection; and
setting an operating strategy for operating the motor vehicle based on the estimated damage of the at least one component.

2. The method as recited in claim 1, wherein the operating strategy is developed as reducing or increasing the damage of the at least one component.

3. The method as recited in claim 1, wherein for each possible operating strategy, a service life of the component to be expected is determined at a given load profile.

4. The method as recited in claim 1, further comprising:
forming a global load profile on the basis of at least one of a speed-time curve or slope-time curve, a temperature, and moisture, resulting during the operation of the motor vehicle.

5. The method as recited in claim 1, further comprising:
forming the connection between a load profile of the at least one component and a damage resulting therefrom on the basis of load parameters, the load parameters being calculated on a model basis or determined with the aid of additional sensors.

6. The method as recited in claim 1, wherein the connection between a load profile of the at least one component and a damage resulting therefrom is made with the aid of an approximation or regression method, the damage being determined for several load profiles with the aid of sensors situated in the motor vehicle and, using the regression method, a generalization of the present specific case being applied to a range of load profiles.

7. The method as recited in claim 6, wherein the regression method is used in advance, sensors being used to determine the damage, and instantaneous damage to the at least one component being ascertained from a previous load profile and from the operating strategy used.

8. The method as recited in claim 1, wherein, assuming an unchanging load profile, a service life to be expected of the at least one component is estimated for varying operating strategies, the operating strategy being set in such a way that a predefined service life of the at least one component is achieved under optimum operating conditions of the motor vehicle.

9. The method as recited in claim 1, wherein a damage of the at least one component is determined cyclically and in previously empirically ascertained time periods based on the load profile used in a previous time period and of a present operating strategy, and the damage thus determined being added to a present damage.

10. The method as recited in claim 1, wherein a remaining service life for various operating strategies is determined on the basis of a load profile used in a previous time period or on the basis of several load profiles used in previous time periods, and based on the results, the operating strategy being set which results in optimum operating conditions of the motor vehicle.

11. The method as recited in claim 1, wherein the damage of the at least one component takes place as a result of a damage parameter which represents a function increasing monotonously over time.

12. The method as recited in claim 11, wherein values of the damage parameter are ascertained through a learning process, instantaneous values of the damage parameter being defined by a linear damage accumulation of partial damages.

13. A computer-readable storage medium storing a computer program for operating a motor vehicle having at least one component which is subject to an operation-dependent aging process, the computer program, when executed on a processor, causing the processor to perform the steps of:
determining a connection between a load profile of the at least one component and a damage resulting therefrom is determined;
estimating damage of the at least one component from the determined connection; and
setting an operating strategy for operating the motor vehicle based on the estimated damage of the at least one component.
